(19) United States
(12) Patent Application Publication
(10) Pub. No.: US 2017/0178590 A1
(43) Pub. Date: Jun. 22, 2017

(54) Wireless Display Sink Device

(71) Applicants: Vallabhajosyula S. Somayazulu, Portland, OR (US); Yiting Liao, Hillsboro, OR (US); Paul S. Diefenbaugh, Portland, OR (US); Krishnan Rajamani, San Diego, CA (US); Kristoffer D. Fleming, Chandler, AZ (US)

(72) Inventors: Vallabhajosyula S. Somayazulu, Portland, OR (US); Yiting Liao, Hillsboro, OR (US); Paul S. Diefenbaugh, Portland, OR (US); Krishnan Rajamani, San Diego, CA (US); Kristoffer D. Fleming, Chandler, AZ (US)

(21) Appl. No.: 14/977,935

(22) Filed: Dec. 22, 2015

(51) Int. Cl. G09G 5/00; H04N 7/01; G06T 1/20; H04N 19/44

(52) U.S. Cl. CPC G09G 5/003; H04N 19/44; H04N 7/0127; G06T 1/20; G09G 2370/16

(57) ABSTRACT

A higher frame rate (a multiple of the original display frame rate at the host) is exploited at a display sink device to opportunistically insert new decoded frames for display at the higher refresh rate of the sink. In other words, delayed frames arriving at the sink may get a chance to be displayed during the higher refresh rate cycle, thus offering a better (“smoother”) viewing experience along with improved interactivity or “responsiveness.”

### BACKGROUND

A wireless display displays data that it receives wirelessly for example using a Realtime Transfer Protocol (RTP) transport and H.264 compression. RTP is an Internet protocol standard for managing real-time transmission of multimedia data over unicast or multicast network services. H.264 compression is a video coding format for block-oriented motion-compensation based video compression according to a standard called H.264/AVC maintained by the Joint Video Team of the ITU-T. An MPEG2 transport stream is a standard container format for transmission and storing of video and audio. See ISO/IEC Standard 13818-1.

Supporting wireless displays is currently one of the most taxing workloads for small form-factor mobile devices. The trends towards higher-resolution (retina quality) displays, thinner and lighter mobile devices with tighter thermal constraints, and increasingly congested networks will increase the workloads of wireless displays. The experience realized on these platforms including battery life, image quality, and end-to-end latency will be seriously challenged absent significant breakthroughs.

Normally, at the sink side, the display frame timing samples the decoded frame buffer at regular intervals and displays the latest available frame. If, at the display side, irregularly arriving frames are all displayed, then a buildup of delay may occur as frames are buffered for display, adversely affecting the responsiveness of the display.

More commonly, the display side processing will drop frames which are delayed beyond the display time, and show only the latest frame. This may impact the user experience due to lack of motion smoothness caused by missing frames. Further, any display side frame rate up conversion is done separately from the wireless display, with frame rate conversion operating on the frames after drops have already occurred.

### BRIEF DESCRIPTION OF THE DRAWINGS

Some embodiments are described with respect to the following figures:

FIG. 1 is a source timing diagram;

FIG. 2 is a sink timing diagram;

FIG. 3 is a sink timing diagram for one embodiment;

FIG. 4 is a flow chart for one embodiment;

FIG. 5 is a schematic depiction for one embodiment; and

FIG. 6 is a system for one embodiment.

### DETAILED DESCRIPTION

A higher frame rate (a multiple of the original display frame rate at the host) is exploited at a display sink device to opportunistically insert new decoded frames for display at the higher refresh rate of the sink. In other words, delayed frames arriving at the sink may get a chance to be displayed during the higher refresh rate cycle, thus offering a better (“smoother”) viewing experience along with improved interactivity or “responsiveness.”

The frame rate is not necessarily uniform. The goal is to display received frames at the earliest opportunity created using finer grained sampling intervals in time. The higher frame rate conversion is integrated further upstream in the receiver side wireless display pipeline, rather than as a post processing step. Since this technique offers additional opportunities to display a delayed frame at the sink, it also benefits from modifications at source side logic to avoid skipping a frame if it could be displayed at the sink.

In particular, the source can optimize for power and quality by encoding static frames to a desired quality target with a larger number of bits than are available for transmission in one frame time. By encoding once and turning to idle, the encoder saves power using a race-to-halt strategy. Then, further frame captures/encodes may be deferred while this ‘jumbo’ frame is transmitted (and new frame updates are accumulated upstream). When such a variable frame rate stream is received at the sink, the method described here is well suited to exploit it to deliver a better quality. This is akin to a lower frame rate encoding—the key difference is that the adjustments are done dynamically and can also be done on a region basis rather than full-frame (if some tools like tile based encoding in High Efficiency Video Coding (HEVC), e.g., are enabled).

While wireless displays are described herein, these techniques are also applicable to other forms of “packetized” display systems with variable-latency communication, including for example display over a universal serial bus (USB) bulk (versus isochronous) transport.

Designing a wireless display solution for power/latency/quality in productivity dominated scenarios can give rise to an adaptive frame rate at the host. Further, at the sink side, normally there is a frame rate conversion (FRC) after the decoder that interpolates between the received picture frames to generate a higher frame rate output. The wireless display receiver, the video decoder (e.g. H.264) and the FRC logic may be integrated together.

Because of the variable frame rates and sizes, the frames may be available at the sink side at different times (due to extremely low latency requirement they may not be buffered deeply). A flexible policy at the sink side looks at the display times at the higher frame-rate output of the FRC and opportunistically inserts one or more delayed frames that have been received with a delay, for example, in a burst of frames. The flexible policy selects which frames to include in the display, thus providing an improved “smoothness” while not unnecessarily sacrificing responsiveness in some embodiments. A simple example would be to look at the frame (time) index of the available frames and create as uniform a spacing in time (at the higher frame rate display output instants) as possible. More complex approaches could look at statistics such as motion and spatial detail (available from the compressed stream or independently inferred) to decide which frames to display in order to keep the temporal ‘flow’ as smooth as possible.

In a normal wireless display sink, there would be a sacrifice of either “smoothness” of playout (by dropping delayed frames) or “responsiveness” (by waiting to display frames as they arrive). Instead, in some embodiments, the sink (i) works with an optimized host side solution that optimizes power subject to latency/quality constraints and (ii) delivers the best possible tradeoff in terms of user perceived quality parameters such as smoothness of playout and responsiveness, by closely integrating and exploiting the host side policy with sink side frame rate upconversion and buffer management.

Typically in energy efficient systems for minimal added latency, the policy at the source is to finish transmission of the large frame and defer or skip succeeding frames as needed to catch up. At the sink, the large frame is made available for display at a delayed time. However, a higher available frame rate at the display creates additional opportunities for displaying the delayed frame—i.e. at fractional frame times with respect to the source frame timing.

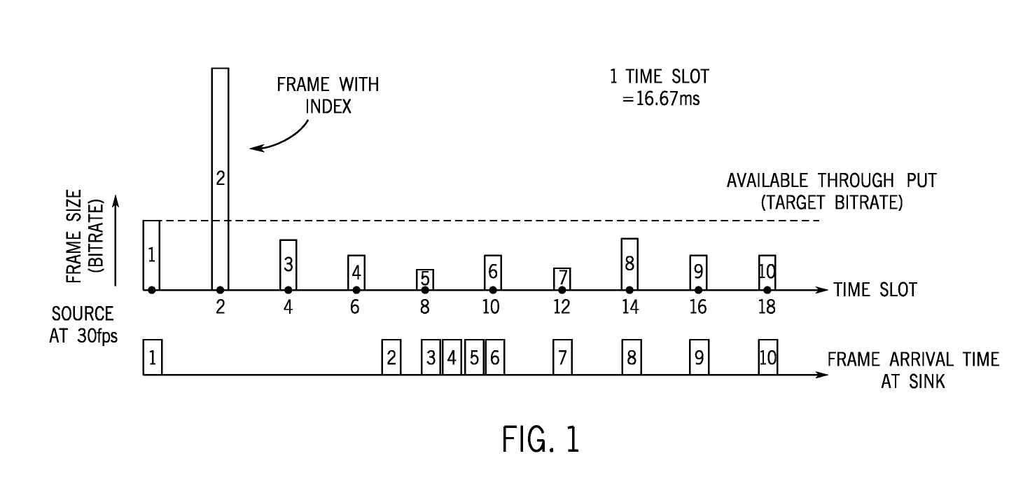

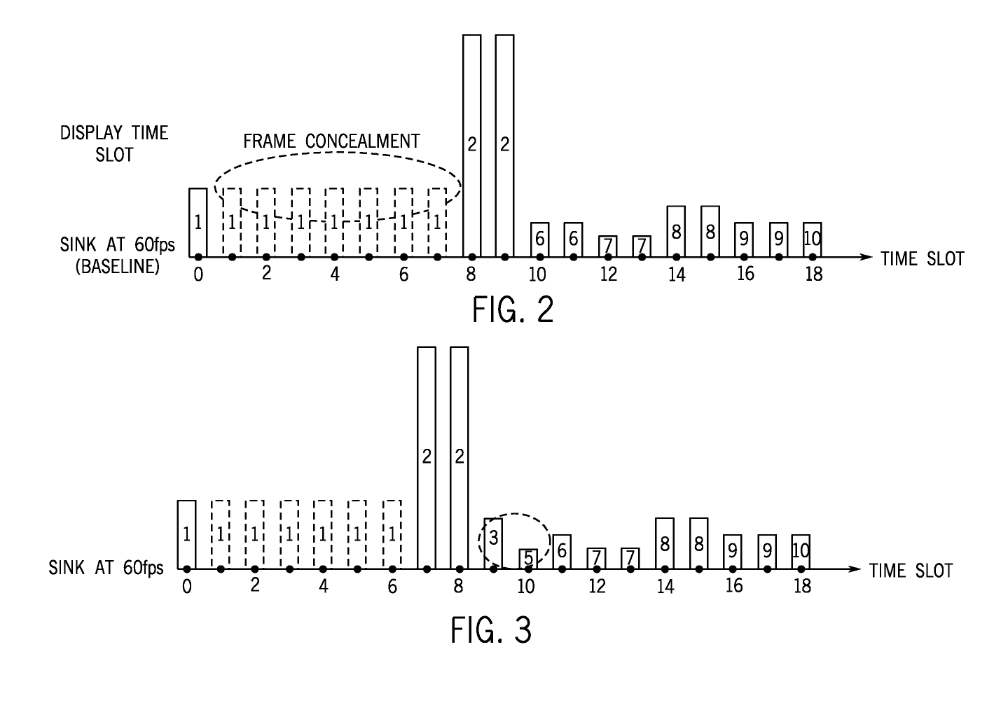

Thus, the wireless display source encoding may be performed at a lower rate (e.g. 30 fps) but the sink has the capability to drive the display at a higher frame rate (e.g. 60 or 120 fps) via frame rate conversion (FRC). In FIG. 1, frame #2 is encoded at a large number of bits at a source. Instead of absorbing this larger frame with a smoothing buffer a low latency system transmits the bits over the multiple frame times, dropping some subsequent frames as needed until the sink can once again catch up to real time as shown in FIG. 2. This can sometimes result in relatively large bursts of dropped frames, which result in a frozen picture on the display. In the baseline method shown in FIG. 3, the available frames are shown twice each (nominal FRC), but this still leads to three skipped frames (frames 3, 4, and 5) not being displayed.

In FIG. 3 according to one embodiment, a multiple of the source frame rate (e.g. 60 fps) is used at the sink to catch up the skipped frames. In the example, two skipped frames (frames 3 and 5) are inserted between frames 2 and 6 to smooth out the display, potentially providing a more pleasing user experience in interactive applications, with fewer stutters and/or frozen frames.

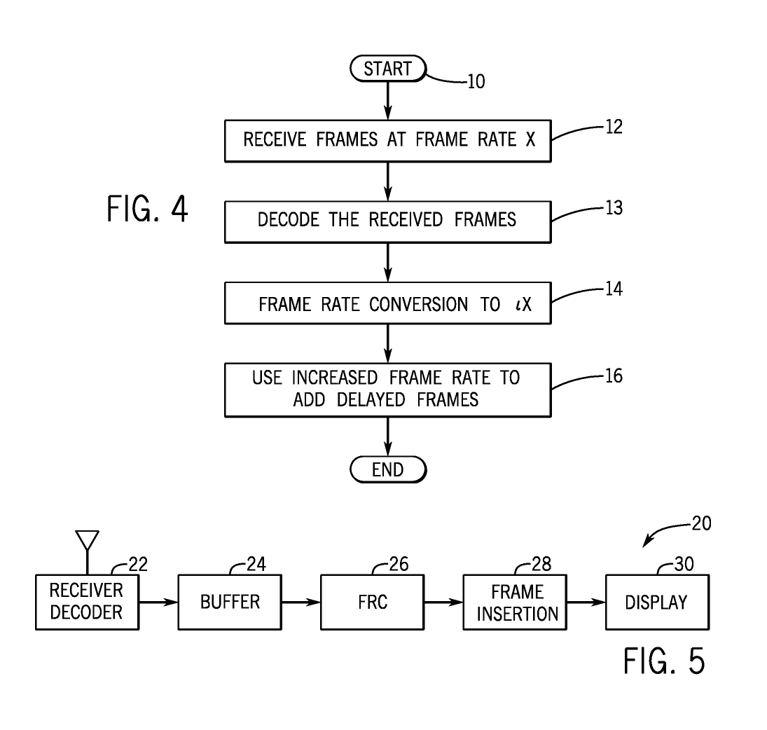

A sequence 10, shown in FIG. 4, at a sink may be implemented in software, hardware and/or firmware. In software and firmware embodiments it may be implemented by computer executed instructions stored in one or more non-transitory computer readable media such as magnetic, optical or semiconductor storage.

The sequence 10 begins by receiving frames wirelessly at a frame rate of x. The received frames are decoded at block 13. For example the receive frame rate may be thirty frames per second and the frame rate is converted at the sink to an integral multiple of x such as 60 or 120 frames per second, as indicated in block 14. Then the increased frame rate is used to add delayed frames as indicated in block 16.

A schematic depiction of a wireless receiver and display 20 is shown in FIG. 5. The receiver and decoder 22 receives a wireless signal from the source. It then buffers the decoded signal as indicated in block 24. Frame rate conversion may be implemented as indicated in block 26. Then based on the amount of frame rate conversion, the number of delayed frames and the size of the frames, some skipped frames may be reinserted as indicated in block 28 for ultimate display on the display 30. In some embodiments, the display may be a separate device and encryption may be used between the frame insertion 28 and the display 30.

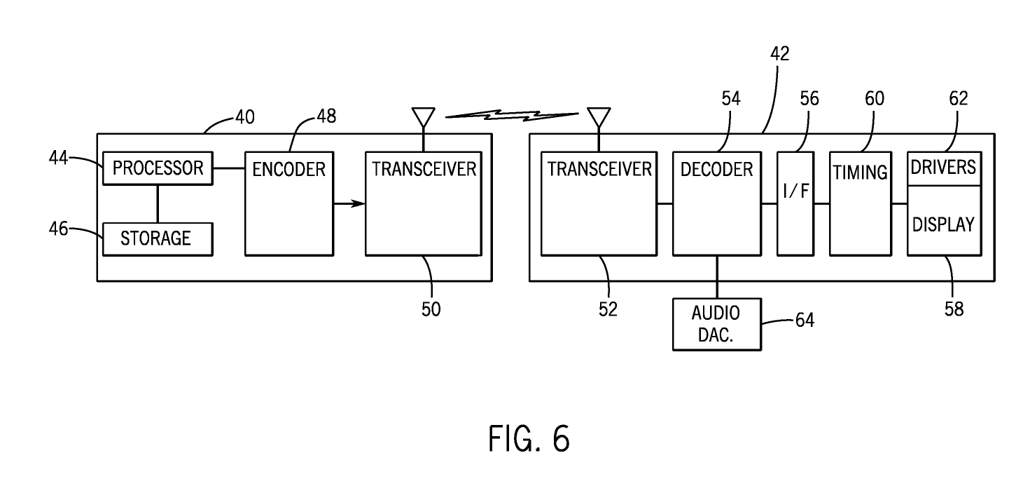

Referring to FIG. 6, a media source 40 may transmit audio and video data wirelessly to a video sink device 42. The transmission may be over any of a variety of wireless protocols including Worldwide Interoperability for Microwave Access (WiMax)(IEEE 802.16), mobile WiMax, IEEE 802.15, Bluetooth, IEEE 802.11, WiFi (IEEE 802.11×), Wireless Gigabit Alliance (WiGig) or cellular, such as 4G, to mention some examples.

The media source 40 may include one or more processors 44 coupled to storage 46. Storage may be provided to store both software and media.

The processor 44 is coupled to an encoder 48. The encoder may encode both video and audio. For example the encoder may include an Motion Pictures Experts Group (ISO/IEC JTC11 SC29/WG11 (Standard ISO/IEC 14496)) (MPEG-4) or H.264 video encoder in accordance with some embodiments. It may also include an audio encoder such as MPEG-2 audio, MPEG-4 audio, Audio Coding 3 (AC-3), Advanced Audio Coding (AAC), or Linear Predictive Coding (LPC) audio encoder.

The encoder couples the encoded media to the transceiver 50 which is responsible for transmitting over the appropriate wireless protocol to the wireless sink device 42 which may include an internal or external display 58.

The wireless sink device 42 includes a transceiver 52 for reception and transmission from the source. The received information is provided to decoder 54. The decoder may decode the received information to one of variety decoded data formats. An interface 56 may be responsible for converting the received information which may be decoded in one format, such as Transition Minimized Differential Signaling (TMDS) or High Definition Multimedia Interference (HDMI) for example, to another format appropriate for the display 58, such as Low Voltage Differential Signaling (LVDS).

The decoder 54 also provides an audio output to an audio digital analog converter (DAC) 64.

The timing of the signal and particularly the video data may be adjusted using a timing controller or T-CON 60. Row and column drivers 62 may drive the display 58. The display may be any of a variety of formats including Liquid Crystal Display (LCD), Field Emission Display (FED), Plasma Display Panel (PDP), Light Emitting Diode (LED) or Electronic Paper Display (EPD), to mention some examples.

The following clauses and/or examples pertain to further embodiments:

One example embodiment may be a method comprising wirelessly receiving frames at a wireless display sink, decoding the frames, increasing the frame rate of the decoded frames, and using the increased frame rate to insert delayed frames. The method may include increasing the frame rate by an integral multiple of a host frame rate. The method may include inserting a number of delayed frames based on the increased sink frame rate, the size of the frames and the number of delayed frames. The method may include determining which frames to display using the increased frame rate based on a frame time index of frames available for display. The method may include creating as uniform a spacing in time as made possible by the increased frame rate. The method may include using statistics to decide which frames to display to keep a smooth temporal flow. The method may include using statistics including using motion and spatial detail statistics. The method may include obtaining statistics from a compressed frame stream including the frames. The method may include inferring the statistics independently of a compressed frame stream including the frames.

Another example embodiment may be one or more non-transitory computer readable media storing instructions to perform a sequence comprising wirelessly receiving frames at a wireless display sink, decoding the frames, increasing the frame rate of the decoded frames, and using the increased frame rate to insert delayed frames. The media may further store instructions to perform a sequence including increasing the frame rate by an integral multiple of a host frame rate. The media may further store instructions to perform a sequence including inserting a number of delayed frames based on the increased sink frame rate, the size of the frames and the number of delayed frames. The media may further store instructions to perform a sequence including determining which frames to display using the increased frame rate based on a frame time index of frames available for display. The media may further store instructions to perform a sequence including creating as uniform a spacing in time as made possible by the increased frame rate. The media may further store instructions to perform a sequence including using statistics to decide which frames to display to keep a smooth temporal flow. The media may further store instructions to perform a sequence including wherein using statistics including using motion and spatial detail statistics. The media may further store instructions to perform a sequence including obtaining statistics from a compressed frame stream including the frames. The media may further store instructions to perform a sequence including inferring the statistics independently of a compressed frame stream including the frames.

In another example embodiment an apparatus comprising a processor to provide wirelessly receiving frames at a wireless display sink, decode the frames, increase the frame rate of the decoded frames and use the increased frame rate to insert delayed frames, and a memory coupled to said processor. The apparatus may include said processor to increase the frame rate by an integral multiple of a host frame rate. The apparatus may include said processor to insert a number of delayed frames based on the increased sink frame rate, the size of the frames and the number of delayed frames. The apparatus may include said processor to determine which frames to display using the increased frame rate based on a frame time index of frames available for display. The apparatus may include said processor to create as uniform a spacing in time as made possible by the increased frame rate. The apparatus may include said processor to use statistics to decide which frames to display to keep a smooth temporal flow. The apparatus may include wherein said processor to use statistics including using motion and spatial detail statistics. The apparatus may include said processor to obtain statistics from a compressed frame stream including the frames. The apparatus may include said processor to infer the statistics independently of a compressed frame stream including the frames. The apparatus may include a transceiver and an antenna

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A method comprising:
wirelessly receiving frames at a wireless display sink;
decoding the frames;
increasing the frame rate of the decoded frames; and
using the increased frame rate to insert delayed frames.

2. The method of claim 1 including increasing the frame rate by an integral multiple of a host frame rate.

3. The method of claim 1 including inserting a number of delayed frames based on the increased sink frame rate, the size of the frames and the number of delayed frames.

4. The method of claim 1 including determining which frames to display using the increased frame rate based on a frame time index of frames available for display.

5. The method of claim 4 including creating as uniform a spacing in time as made possible by the increased frame rate.

6. The method of claim 1 including using statistics to decide which frames to display to keep a smooth temporal flow.

7. The method of claim 6 wherein using statistics including using motion and spatial detail statistics.

8. The method of claim 7 including obtaining statistics from a compressed frame stream including the frames.

9. The method of claim 7 including inferring the statistics independently of a compressed frame stream including the frames.

10. One or more non-transitory computer readable media storing instructions to perform a sequence comprising:
wirelessly receiving frames at a wireless display sink;
decoding the frames;
increasing the frame rate of the decoded frames; and
using the increased frame rate to insert delayed frames.

11. The media of claim 10 including increasing the frame rate by an integral multiple of a host frame rate.

12. The media of claim 10 including inserting a number of delayed frames based on the increased sink frame rate, the size of the frames and the number of delayed frames.

13. The media of claim 10 including determining which frames to display using the increased frame rate based on a frame time index of frames available for display.

14. The media of claim 13 including creating as uniform a spacing in time as made possible by the increased frame rate.

15. The media of claim 10 including using statistics to decide which frames to display to keep a smooth temporal flow.

16. The media of claim 15 wherein using statistics including using motion and spatial detail statistics.

17. The media of claim 16 including obtaining statistics from a compressed frame stream including the frames.

18. The media of claim 16 including inferring the statistics independently of a compressed frame stream including the frames.

19. An apparatus comprising:
a processor to provide wirelessly receiving frames at a wireless display sink, decode the frames, increase the frame rate of the decoded frames and use the increased frame rate to insert delayed frames; and
a memory coupled to said processor.

20. The apparatus of claim 19, said processor to increase the frame rate by an integral multiple of a host frame rate.

21. The apparatus of claim 19, said processor to insert a number of delayed frames based on the increased sink frame rate, the size of the frames and the number of delayed frames.

22. The apparatus of claim 19, said processor to determine which frames to display using the increased frame rate based on a frame time index of frames available for display.

23. The apparatus of claim 22, said processor to create as uniform a spacing in time as made possible by the increased frame rate.

24. The apparatus of claim 19, said processor to use statistics to decide which frames to display to keep a smooth temporal flow.

25. The apparatus of claim 24, wherein said processor to use statistics including using motion and spatial detail statistics.

26. The apparatus of claim 25, said processor to obtain statistics from a compressed frame stream including the frames.

27. The apparatus of claim 25, said processor to infer the statistics independently of a compressed frame stream including the frames.

28. The apparatus of claim 19 including a transceiver.

29. The apparatus of claim 28 including an antenna.
